(19) United States
(12) Patent Application Publication
(10) Pub. No.: US 2024/0383007 A1
(43) Pub. Date: Nov. 21, 2024

(54) SORTING APPARATUS AND SORTING METHOD

(71) Applicant: Yazaki Corporation, Tokyo (JP)

(72) Inventor: Kazuhiko TAKADA, Makinohara-shi (JP)

(73) Assignee: Yazaki Corporation, Tokyo (JP)

(21) Appl. No.: 18/639,182

(22) Filed: Apr. 18, 2024

(30) Foreign Application Priority Data
May 18, 2023 (JP) 2023-081973

(51) Int. Cl. B07B 1/24; B07B 1/46; B07B 13/16

(52) U.S. Cl. CPC B07B 1/24; B07B 1/4609; B07B 13/16

(57) ABSTRACT

A sorting apparatus for unsorted nuggets includes a frame, a first sieve including a mesh, the unsorted nuggets being charged into the first sieve, a trimming unit configured to cut the wire-shaped conductors sticking out from the mesh of the first sieve, a shredding unit configured to shred the unsorted nuggets remaining in the first sieve, a second sieve including a mesh that is finer than the mesh of the first sieve, the unsorted nuggets shredded by the shredding unit being charged into the second sieve, a collecting unit configured to collect the wire-shaped conductors having passed through and sieved off with the mesh of the first sieve, the wire-shaped conductors having passed through and sieved off with the mesh of the second sieve, and the wire-shaped conductors having been cut by the trimming unit, and a control unit.

### TECHNICAL FIELD

The present invention relates to a sorting apparatus and a sorting method of unsorted nuggets including wire-shaped conductors and non-wire-shaped materials including terminals, which are cut and are present in a mixed manner.

### BACKGROUND

Automobiles are equipped with wire harnesses for connecting in-vehicle devices. For example, a wire harness includes an electric wire in which a pure copper wire-shaped conductor is covered with an insulating coating, a copper alloy terminal connected to the end of the electric wire, and a resin connector housing that houses the terminal. Such wire harnesses are removed from scrapped cars and recycled (see, for example, Patent Document 1).

### RELATED ART

### Patent Document

Patent Document 1: JP H7-9280 A

### SUMMARY OF THE INVENTION

### Problem to be Solved by the Invention

In the process of recycling of wire harnesses, waste materials including only pure copper-coated electric wires with no foreign metals such as terminals being mixed in can be separated into waste plastic and pure copper (wire-shaped conductors). However, since it is difficult to separate waste materials that contain different metals such as terminals, materials from which waste plastics have been removed (materials including a mixture of wire-shaped conductors and non-wire-shaped materials such as terminals) are collected as “unsorted nuggets”. Unsorted nuggets have a pure copper content of about 92-97% and cannot be reused as electric wire materials. Furthermore, extracting pure copper using existing methods such as electrolytic refining is too expensive and impractical.

Therefore, it is an object of the present invention to provide a sorting apparatus and a sorting method that can recover as much wire-shaped conductors as possible from unsorted nuggets and improve the yield of wire harness recycling.

### Solution to Problem

According to an aspect of the present invention, a sorting apparatus for unsorted nuggets including wire-shaped conductors and non-wire-shaped materials including terminals, the wire-shaped conductors and the non-wire-shaped materials being cut and present in a mixed manner, includes a first sieve including a mesh, the unsorted nuggets being charged into the first sieve, a shredding unit configured to shred the unsorted nuggets remaining in the first sieve, a second sieve including a mesh that is finer than the mesh of the first sieve, the unsorted nuggets shredded by the shredding unit being charged into the second sieve, and a collecting unit configured to collect the wire-shaped conductors having passed through and sieved off with the mesh of the first sieve and the wire-shaped conductors having passed through and sieved off with the mesh of the second sieve.

According to an aspect of the present invention, a sorting method for unsorted nuggets including wire-shaped conductors and non-wire-shaped materials including terminals, the wire-shaped conductors and the non-wire-shaped materials being cut and present in a mixed manner, includes a first sieving step of charging the unsorted nuggets into a first sieve including a mesh, and sieving off the wire-shaped conductors with the first sieve, a shredding step of shredding the unsorted nuggets remaining in the first sieve after the first sieving step, a second sieving step of charging the unsorted nuggets shredded in the shredding step into a second sieve including a mesh finer than the mesh of the first sieve to sieve off the wire-shaped conductors with the second sieve, and a collecting step of collecting the wire-shaped conductors having passed through and sieved off with the mesh of the first sieve and the wire-shaped conductors having passed through and sieved off with the mesh of the second sieve.

### Advantageous Effects of the Invention

According to an aspect of the present invention, wire-shaped conductors, which did not fall through the first sieve, fall through the second sieve, and therefore, more wire-shaped conductors can be collected from unsorted nuggets, and the yield of wire harness recycling can be improved.

### BRIEF DESCRIPTION OF THE DRAWINGS

FIG. 1 is a perspective view of a sorting apparatus for unsorted nuggets according to an embodiment of the present invention.

FIG. 2 is a plan view of the sorting apparatus illustrated in FIG. 1.

FIG. 3 is a side view of the sorting apparatus illustrated in FIG. 1.

FIG. 4 is an enlarged view of a main portion of the sorting apparatus illustrated in FIG. 2.

FIG. 5 is a cross-sectional view taken along line A-A of FIG. 4.

FIG. 6 is an enlarged view of a main portion of the sorting apparatus illustrated in FIG. 5.

FIG. 7 is a perspective view of a first sieve illustrated in FIG. 1.

FIG. 8 is a cross-sectional view taken along line B-B of FIG. 4.

FIG. 9 is a cross-sectional view illustrating a state in which a rotating blade of a trimming unit of FIG. 8 is rotated.

FIG. 10 is a cross-sectional view illustrating a state in which the rotating blade of FIG. 9 rotates and cuts wire-shaped conductors sticking out from the eyes of the mesh.

### DETAILED DESCRIPTION OF THE EXEMPLARY EMBODIMENT

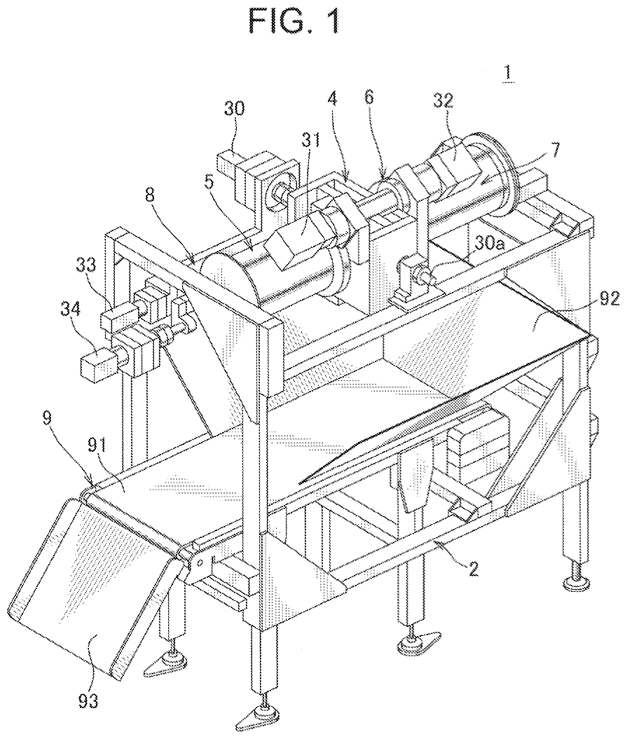

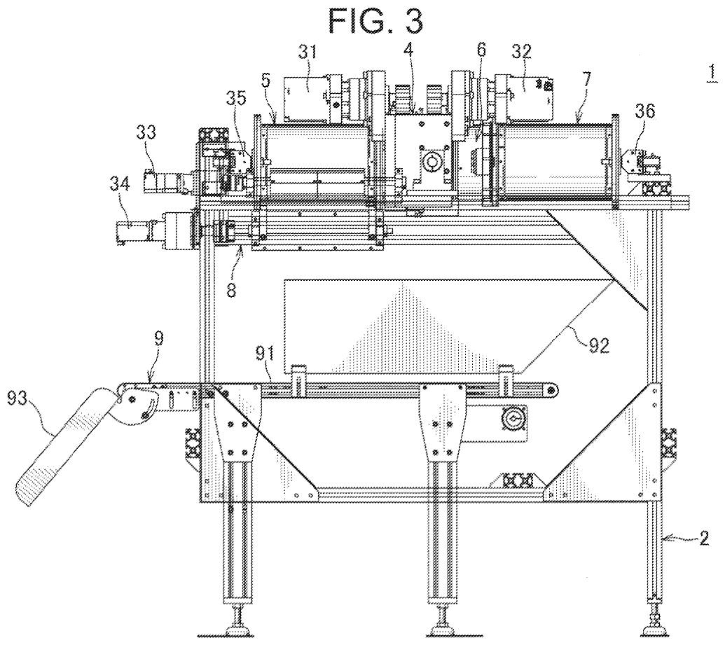

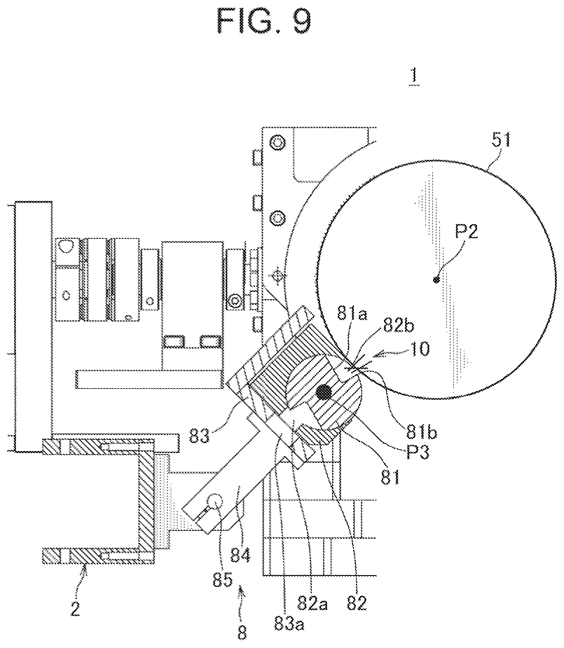

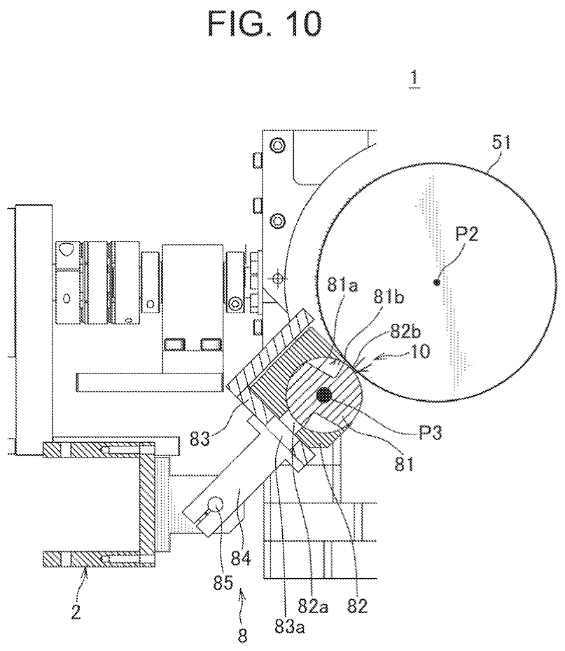

A sorting apparatus 1 and a sorting method according to an embodiment of the present invention are explained with reference to FIGS. 1 to 10.

The sorting apparatus 1 illustrated in FIGS. 1 to 4 is a sorting apparatus of “unsorted nuggets” obtained from wire harnesses removed from scrapped cars and subjected to several dismantling steps. The unsorted nuggets include pure copper wire-shaped conductors from which insulating coatings have been removed and non-wire-shaped materials including copper alloy terminals, which are cut and are present in a mixed manner. The wire-shaped conductors included in these unsorted nuggets have a diameter of 0.2 mm and a length of several mm. The sorting apparatus 1 is for recovering pure copper (wire-shaped conductors) from the unsorted nuggets.

The sorting apparatus 1 includes a frame 2 installed on a floor, a first sieve 5, a shredding unit 6, a second sieve 7, a communicating portion 41, a support portion 4, lid portions 11 to 14, motors 30 to 32, a trimming unit 8, a collecting unit 9, multiple air cylinders, a control unit (not illustrated), and the like.

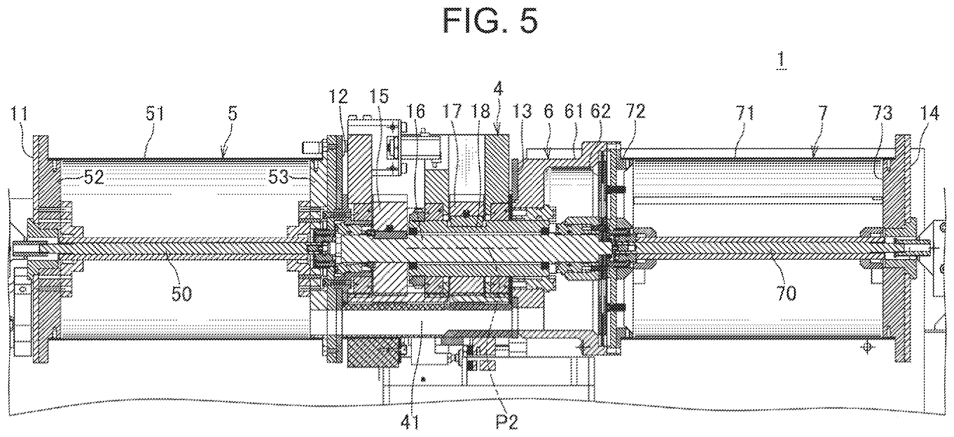

The unsorted nuggets are charged into the first sieve 5, and the first sieve 5 sieves the unsorted nuggets to allow wire-shaped conductors to fall through the first sieve 5. As illustrated in FIG. 5, the first sieve 5 includes a mesh 51 in a cylindrical shape, a plate portion 52 attached to an opening on one end side of the mesh 51, a plate portion 53 attached to an opening on the other end side of the mesh 51, and a support pillar 50 connected to the plate portion 52 and the plate portion 53.

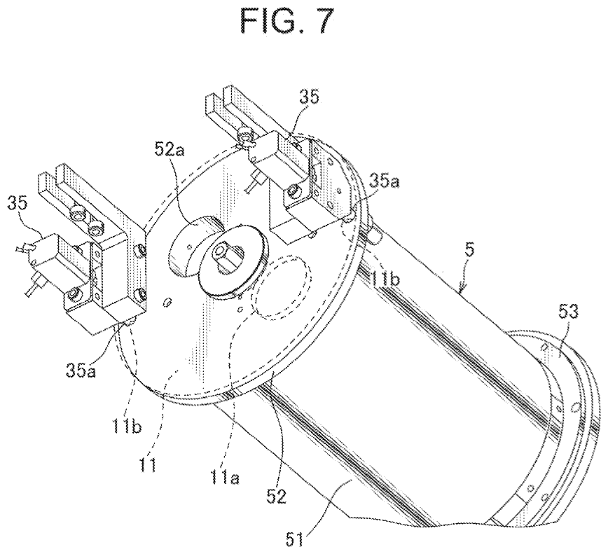

The mesh 51 has an opening of 0.44 mm. The support pillar 50 is provided to pass through the center axis of the first sieve 5. The plate portion 52 is attached to the one end side of the mesh 51, i.e., the opening on the side opposite to the second sieve 7. The plate portion 52 is formed into a disk shape and closes the opening, but has a through hole 52a through which the unsorted nuggets are charged, as illustrated in FIG. 7.

As illustrated in FIGS. 5, 7, the lid portion 11 in a disk shape is placed on the outer surface of the plate portion 52. The lid portion 11 is provided rotatably with respect to the plate portion 52. A through hole 11a is formed in the lid portion 11 to overlap the through hole 52a of the plate portion 52. When the unsorted nuggets are charged into the first sieve 5, these through holes 52a and 11a are positioned to overlap each other, and after the charging, the through holes 52a and 11a are positioned so as not to overlap each other. The through hole 52a is opened and closed by rotating the first sieve 5 while the lid portion 11 is fixed immovably.

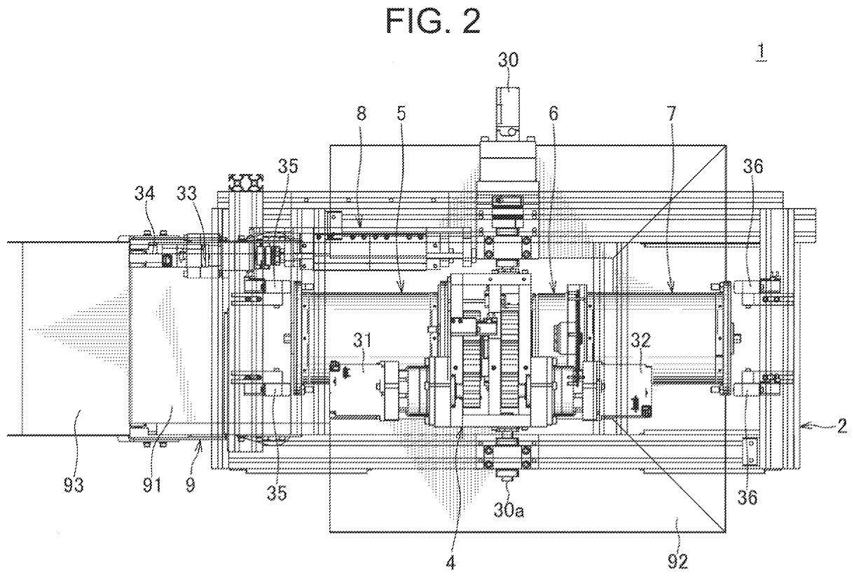

Furthermore, the lid portion 11 is fixed by a pair of air cylinders 35 (see FIG. 2) attached to the frame 2. The air cylinder 35 has a retractable pin 35a. The pin 35a extends toward the lid portion 11 and is inserted into a hole 11b formed in the lid portion 11, thereby fixing the lid portion 11 to the frame 2. When the pin 35a contracts in the direction away from the lid portion 11 and moves out of the hole 11b, the fixation of the lid portion 11 is released. The operation of the air cylinders 35 is controlled by the control unit.

In FIG. 7, the lid portion 11 is indicated with a broken line in order to visualize the through hole 52a of the plate portion 52, but the lid portion 11 indicated with this broken line actually exists.

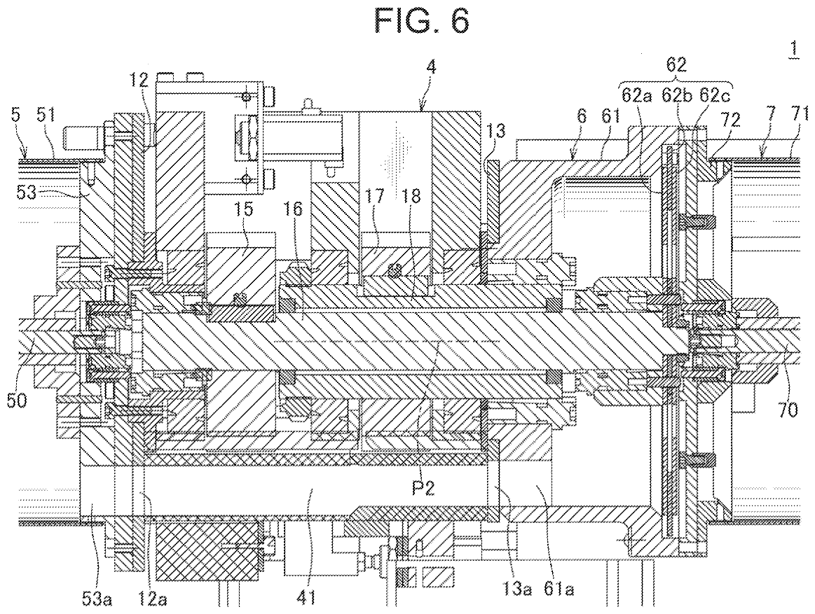

The first sieve 5 is rotated around its center axis (the support pillar 50) by a motor 31 (corresponding to a “first driving unit”). The drive of the motor 31 is controlled by the control unit explained above. Further, the rotational force of the motor 31 is transmitted to the first sieve 5 via a gear 15, a shaft 16, and the like illustrated in FIG. 6. As the first sieve 5 into which the unsorted nuggets are charged rotates around its center axis, wire-shaped conductors pass and fall through the mesh 51.

The shredding unit 6 shreds unsorted nuggets that did not fall through the first sieve 5 and are remaining inside the first sieve 5. As illustrated in FIGS. 5 and 6, the shredding unit 6 includes a case 61 in a cylindrical shape with a bottom and a cutter 62 attached to the case 61. The case 61 and the cutter 62 form a space between them. This space is to accommodate the supplied unsorted nuggets. The case 61 is connected to the second sieve 7, and the cutter 62 is adjacent to the second sieve 7.

The cutter 62 includes three rotating blades 62a, 62b, 62c overlapping each other. The middle second rotating blade 62b of the three blades is fixed to case 61. The first rotating blade 62a and the third rotating blade 62c sandwiching the second rotating blade 62b are provided rotatably with respect to the case 61. The first rotating blade 62a and the second rotating blade 62b rotate in opposite directions, and the first rotating blade 62a and the third rotating blade 62c rotate in the same direction. The rotating blades 62a, 62b, and 62c are formed with holes that overlap each other at a certain timing during rotation. The unsorted nuggets are cut when the rotating blades 62a, 62b and the rotating blade 62b rotate in the opposite directions while the unsorted nuggets are passed through these holes.

The holes of the rotating blades 62a, 62b, 62c are in communication with the internal space of the second sieve 7 at a point in time when they overlap each other. As a result, the unsorted nuggets having been cut are situated in the internal space of the second sieve 7.

The first rotating blade 62a and the third rotating blade 62c are driven by the motor 31 to rotate together with the first sieve 5. The second rotating blade 62b is rotated by the motor 32 (corresponding to a “second driving unit”) together with the second sieve 7 and the case 61. As described above, in this embodiment, the number of motors is reduced by rotating the rotating blade and the sieve using a common motor, but the rotating blade and sieve may be rotated by respective dedicated motors.

The unsorted nuggets shredded by the shredding unit 6 are charged into the second sieve 7, and the second sieve 7 sieves the unsorted nuggets to allow wire-shaped conductors to fall through the second sieve 7. As illustrated in FIG. 5, the second sieve 7 includes a mesh 71 in a cylindrical shape, a plate portion 72 attached to an opening on one end side of the mesh 71, a plate portion 73 attached to an opening on the other end side of the mesh 71, and a support pillar 70 connected to the plate portion 72 and the plate portion 73.

The mesh 71 has an opening of 0.385 mm, which is finer than the mesh 51 of the first sieve 5. The reason why the mesh 71 of the second sieve 7 is finer than the mesh 51 of the first sieve 5 is to prevent non-wire-shaped materials (i.e., materials other than the wire-shaped conductors, e.g., terminals and the like) included in the unsorted nuggets shredded by the shredding unit 6 from passing through the openings of the mesh 71.

The support pillar 70 is provided to pass through the center axis of the second sieve 7. The plate portion 72 is attached to one end side of the mesh 71, i.e., an opening on the side of the shredding unit 6. The plate portion 72 is formed in a disk shape to close the opening, and a through hole is formed in the plate portion 72 to allow the unsorted nuggets to pass through from the shredding unit 6. The plate portion 73 is attached to the other end side of the mesh 71, i.e., an opening on a side opposite to the shredding unit 6. The plate portion 73 is formed in a disk shape to close the opening, and a through hole is formed in the plate portion 73 to discharge the unsorted nuggets that did not fall through the second sieve 7 and are remaining inside the second sieve 7.

Also, as illustrated in FIG. 5, the lid portion 14 in a disk shape is placed on the outer surface of the plate portion 73. The lid portion 14 is provided rotatably with respect to the plate portion 73. A through hole is formed in the lid portion 14 to overlap the through hole of the plate portion 73. When the unsorted nuggets are discharged, these through holes are positioned to overlap each other, and except when discharging, the through holes are positioned so as not to overlap each other. The through hole is opened and closed by rotating the second sieve 7 while the lid portion 14 is fixed immovably. Similarly to the fixing of the lid portion 11, the lid portion 14 is fixed by a pair of air cylinders 36 (see FIG. 2) attached to the frame 2. The operation of the air cylinders 36 is similar to that of the air cylinders 35, and is controlled by the control unit described above.

The second sieve 7 is rotated around its center axis (the support pillar 70) by the motor 32. The drive of the motor 32 is controlled by the control unit explained above. Further, the rotational force of the motor 32 is transmitted to the second sieve 7 via a gear 17, a shaft 18, and the like illustrated in FIG. 6. As the second sieve 7 into which the unsorted nuggets are charged rotates around its center axis, wire-shaped conductors pass and fall through the mesh 71.

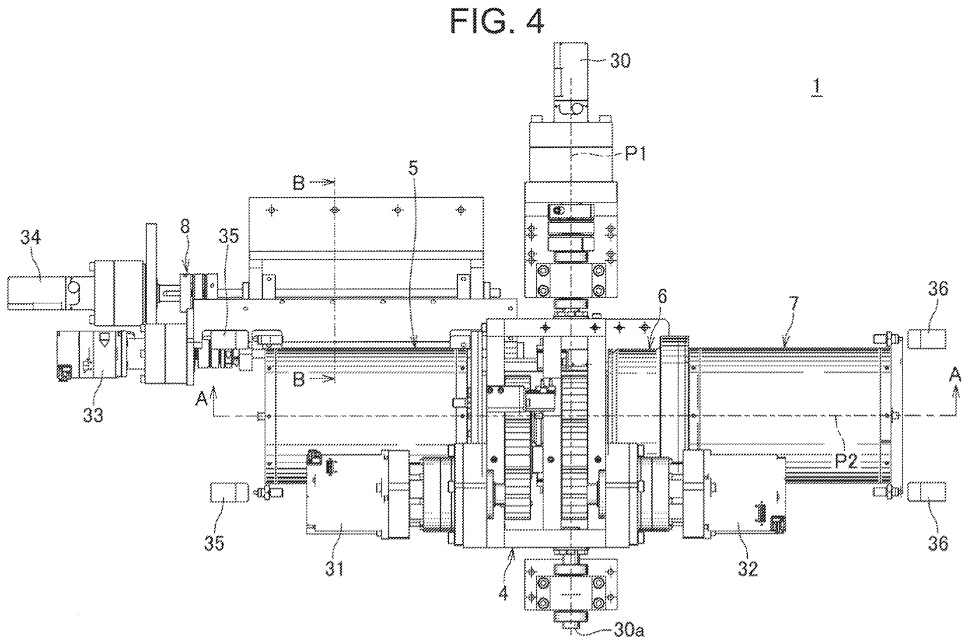

The support portion 4 is provided between the first sieve 5 and the shredding unit 6 to rotatably support the first sieve 5, the shredding unit 6, the second sieve 7, and the motors 31, 32 and non-rotatably support the communicating portion 41. The communicating portion 41 is a portion that allows the first sieve 5 and the shredding unit 6 to be in communication with each other to pass unsorted nuggets. The first sieve 5 and the second sieve 7 supported by the support portion 4 have their respective center axes arranged on the same straight line (a long dashed short dashed line P2 illustrated in FIG. 4 and the like).

A shaft 30a of the motor 30 (corresponding to a “third driving unit”) attached to the frame 2 is connected to the support portion 4. The support portion 4 rotates around the shaft 30a. The center line of the shaft 30a is illustrated in FIG. 4 with a long dashed short dashed line P1. The shaft 30a extends horizontally. The motor 30 rotates the support portion 4 so that the center axes of the first sieve 5 and second sieve 7 become horizontal or vertical. The drive of the motor 30 is controlled by the control unit explained above.

As illustrated in FIG. 6, the lid portion 12 is arranged between the first sieve 5 and the communicating portion 41, and the first sieve 5 and the communicating portion 41 are brought into a communicating state or a non-communicating state. The lid portion 12 is formed in a disk shape and placed on the outer surface of the plate portion 53 of the first sieve 5. The lid portion 12 is provided rotatably with respect to the plate portion 53. A through hole 12a is formed in the lid portion 12 to overlap the through hole 53a of the plate portion 53. When these through holes 53a and 12a are situated at positions where they overlap each other, the first sieve 5 and the communicating portion 41 are in communicating state to pass unsorted nuggets. When the through holes 53a and 12a are situated at positions where they do not overlap each other, the first sieve 5 and the communicating portion 41 are in non-communicating state to block unsorted nuggets.

The through hole 53a is opened and closed by rotating the first sieve 5 while the lid portion 12 is fixed immovably. The lid portion 12 is fixed by a pair of air cylinders, not illustrated, fixed to the support portion 4. The operation of the air cylinders is similar to that of the air cylinders 35, 36 explained above, and is controlled by the control unit described above.

As illustrated in FIG. 6, the lid portion 13 is arranged between the communicating portion 41 and the shredding unit 6, and the communicating portion 41 and the shredding unit 6 are brought into a communicating state or a non-communicating state. The lid portion 13 is formed in a disk shape and placed on the outer surface of the case 61 of the shredding unit 6. The lid portion 13 is provided rotatably with respect to the case 61. A through hole 13a is formed in the lid portion 13 to overlap the through hole 61a formed in the case 61. When these through holes 61a and 13a are situated at positions where they overlap each other, the communicating portion 41 and the shredding unit 6 are in communicating state to pass unsorted nuggets. When the through holes 61a and 13a are situated at positions where they do not overlap each other, the communicating portion 41 and the shredding unit 6 are in non-communicating state to block unsorted nuggets.

The through hole 61a is opened and closed by rotating the case 61 while the lid portion 13 is fixed immovably. The lid portion 13 is fixed by a pair of air cylinders, not illustrated, fixed to the support portion 4. The operation of the air cylinders is similar to that of the air cylinders 35, 36 explained above, and is controlled by the control unit described above.

The trimming unit 8 cuts wire-shaped conductor sticking out from the mesh 51 of the first sieve 5. As illustrated in FIGS. 4 and 8 to 10, the trimming unit 8 includes a rotating blade 81, a fixed blade 82, a fixed member 83 fixed to the fixed blade 82, an arm 84 connected to the fixed member 83, a shaft 85, and motors 33, 34.

The rotating blade 81 has notches 81a formed on the outer periphery of a cylindrical member, and rotates around its center axis P3 by the motor 33 controlled by the control unit. The center axis P3 is parallel to the center axis P2 of the first sieve 5.

The fixed blade 82 is placed close to the mesh 51 of the first sieve 5. The fixed blade 82 is provided so as to expose a portion of the rotating blade 81 facing the mesh 51 and to surround the portion other than the exposed portion.

The arm 84 is rotatably attached to the frame 2 by the shaft 85. Further, the rotational force of the motor 34 controlled by the control unit is transmitted to the arm 84 via the shaft 85, so that the arm 84 rotates around the shaft 85. As the arm 84 rotates, the rotating blade 81 and the fixed blade 82 are at a proximity position to the mesh or at a distant position from the mesh 51.

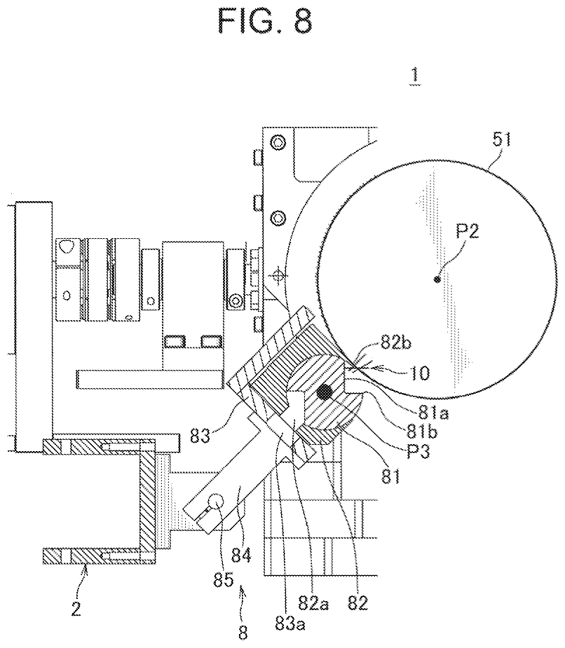

FIGS. 8 to 10, the rotating blade 81 rotates relative to the fixed blade 82, and wire-shaped conductors 10 sticking out from the mesh 51 are sandwiched between an edge 82b of the fixed blade 82 and an edge 81b of the rotating blade 81, so that the wire-shaped conductors 10 are cut. Pieces of the wire-shaped conductors 10 having been cut are situated within the notch 81a to move together with the rotating blade 81, and pass through the through hole 82a formed in the fixed blade 82 and the through hole 83a formed in the fixed member 83 and then fall (trimming step).

The collecting unit 9 collect wire-shaped conductors having been sieved by and having sieved through the mesh 51 of the first sieve 5 and the mesh 71 of the second sieve 7 and wire-shaped conductors having been cut by the trimming unit 8. The collecting unit 9 includes a conveyor 91 attached to the frame 2, a first sieve 5, a guide plate 92 collecting, to the side of the conveyor 91, the wire-shaped conductors having fallen from the second sieve 7, and a slope 93 provided on the one end side of the conveyor 91, collection containers, and the like.

The collection containers include a collection container for collecting wire-shaped conductors and a collection container for collecting unsorted nuggets discharged from the second sieve 7. The collection container for wire-shaped conductors is provided below the slope 93. The collection container for unsorted nuggets is provided on the other end side of the conveyor 91. When the conveyor 91 rotates forward, the wire-shaped conductors are collected into the collection container for wire-shaped conductors. When the conveyor 91 rotates backward, the unsorted nuggets are collected into the collection container for unsorted nuggets.

The unsorted nuggets are discharged from the second sieve 7 after the sieving steps of the first sieve 5 and the second sieve 7, so that wire-shaped conductors and unsorted nuggets are prevented from being mixed on the conveyor 91. The discharge step of these unsorted nuggets and the rotation control of the conveyor 91 are controlled by the control unit explained above.

An example of a sorting method using the sorting apparatus 1 explained above is hereinafter explained. First, unsorted nuggets are charged into the first sieve 5. After charging, the first sieve 5 rotates according to a preprogrammed rotation pattern to sieve wire-shaped conductors (first sieving step). After this first sieving step is performed for a predetermined period of time, the rotating blade 81 and the fixed blade 82 of the trimming unit 8 move from the distant position to the proximity position with respect to the mesh 51, and the trimming step explained above is performed. The collecting unit 9 operates in parallel to the first sieving step and the trimming step, and the wire-shaped conductors collected on the conveyor 91 are collected into the collection container for wire-shaped conductors (collecting step).

After this trimming step is performed for a predetermined period of time, the first sieve 5 and the shredding unit 6 are brought into communication with each other by the communicating portion 41. Then, when the communicating portion 41 is tilted by the drive of motor 30, the unsorted nuggets are moved from the first sieve 5 to the shredding unit 6.

Next, the shredding unit 6 performs a shredding step of unsorted nuggets. With the shredding unit 6 being positioned at the top and the second sieve 7 being positioned at the bottom by the drive of the motor 30, the cutter 62 operates to provide shredded unsorted nuggets to the second sieve 7. The unsorted nuggets once supplied to the second sieve 7 may be moved back to the shredding unit 6 to perform the shredding step multiple times. The unsorted nuggets can be moved from the second sieve 7 to the shredding unit 6 by driving the motor 30 and positioning the shredding unit 6 at the bottom and positioning the second sieve 7 at the top.

After the shredded unsorted nuggets are charged into the second sieve 7, the second sieve 7 rotates according to a preprogrammed rotation pattern to sieves wire-shaped conductors (second sieving step). Also, the collecting unit 9 operates in parallel with the second sieving step, and wire-shaped conductors collected on the conveyor 91 are collected into the collection container for wire-shaped conductors (collecting step). After this second sieving step is completed, the conveyor 91 stops, and the unsorted nuggets remaining in the second sieve 7 are discharged. When the unsorted nuggets are discharged onto the conveyor 91, the conveyor 91 rotates backward to collect the unsorted nuggets into the collection container for unsorted nuggets. The series of steps described above are performed by the control unit executing a preset program.

Further, in the first sieving step by the first sieve 5 and the second sieving step by the second sieve 7 explained above, the following rotation pattern is executed. That is, the sieves 5, 7 rotate in a rotation pattern that includes a rotation in the forward direction by a first angle, then a rotation in the reverse direction by a second angle different from the first angle, and then a rotation in the forward direction by a third angle different from the first and second angles. The first angle is, for example, 270 degrees, the second angle is, for example, 90 degrees, and the third angle is, for example, 180 degrees. With such a rotation pattern, wire-shaped conductors can be prevented from staying at certain portions of the sieves 5 and 7, and wire-shaped conductors caught in the meshes 51 and 71 can be passed through.

The sorting apparatus I explained above allows wire-shaped conductors, which did not fall through the first sieve 5, to fall through the second sieve 7 after shredding by the shredding unit 6. Because the mesh 71 of the second sieve 7 is finer than the mesh 51 of the first sieve 5, non-wire-shaped materials (i.e., materials other than the wire-shaped conductors, e.g., terminals and the like) included in the unsorted nuggets shredded by the shredding unit 6 can be prevented from passing through the openings of the mesh 71, so that a high level of copper purity can be maintained. Therefore, more wire-shaped conductors can be collected from unsorted nuggets, and the yield of wire harness recycling can be improved.

In the above-described embodiment, the mesh 51 has an opening of 0.44 mm, and the mesh 71 has an opening of 0.385 mm, which are opening dimensions suitable for wire-shaped conductors with a thickness of 0.2 mm of the above-described embodiment. In the present invention, the opening dimensions of the mesh can be changed according to the thickness of the wire-shaped conductor, the target collection rate, and the purity of wire-shaped conductors.

In the above-described embodiment, the trimming unit 8 is provided only for the first sieve 5, but the trimming unit 8 may be provided for second sieve 7, or the trimming unit 8 may be provided for each of the first sieve 5 and the second sieve 7.

In the above-described embodiment, the sorting apparatus 1 is used to collect wire-shaped conductors made of pure copper, but the wire-shaped conductors of the present invention are not limited to pure copper, and may be made of aluminum, for example. The sorting apparatus 1 may be used to collect wire-shaped conductors made of aluminum.

Note that the above-described embodiment merely shows a typical form of the present invention, and the present invention is not limited to the above embodiment. That is, various modifications can be made without departing from the gist of the invention. It is to be understood that such modifications are included within the scope of the present invention as long as they still have the structure of the present invention.

### LIST OF REFERENCE SIGNS

1 sorting apparatus
2 frame
4 support portion
5 first sieve
6 shredding unit
7 second sieve
8 trimming unit
9 collecting unit
41 communicating portion
51, 71 mesh

What is claimed is:

1. A sorting apparatus for unsorted nuggets including wire-shaped conductors and non-wire-shaped materials including terminals, the wire-shaped conductors and the non-wire-shaped materials being cut and present in a mixed manner, comprising:
a first sieve including a mesh, the unsorted nuggets being charged into the first sieve;
a shredding unit configured to shred the unsorted nuggets remaining in the first sieve;
a second sieve including a mesh that is finer than the mesh of the first sieve, the unsorted nuggets shredded by the shredding unit being charged into the second sieve; and
a collecting unit configured to collect the wire-shaped conductors having passed through and sieved off with the mesh of the first sieve and the wire-shaped conductors having passed through and sieved off with the mesh of the second sieve.

2. The sorting apparatus according to claim 1, further comprising:
a trimming unit configured to cut the wire-shaped conductors sticking out from the mesh of the first sieve or the mesh of the second sieve,
wherein the collecting unit collects the wire-shaped conductors having been cut by the trimming unit.

3. The sorting apparatus according to claim 1, wherein the shredding unit is connected to the second sieve, and
the sorting apparatus further comprises a communicating portion allowing the first sieve and the shredding unit to be in communication with each other.

4. The sorting apparatus according to claim 3, further comprising:
a lid portion provided between the first sieve and the communicating portion to bring the first sieve and the communicating portion into a communicating state or a non-communicating state; and
another lid portion provided between the communicating portion and the shredding unit to bring the communicating portion and the shredding unit into a communicating state or a non-communicating state.

5. The sorting apparatus according to claim 3, wherein each of the mesh of the first sieve and the mesh of the second sieve is formed in a cylindrical shape,
a center axis of the first sieve and a center axis of the second sieve are arranged on a same straight line,
wherein the sorting apparatus comprises:
a first driving unit configured to rotate the first sieve about its center axis;
a second driving unit configured to rotate the second sieve about its center axis; and
a third driving unit configured to rotate a support portion supporting the first sieve, the communicating portion, the shredding unit, and the second sieve, and
wherein the third driving unit rotates the first sieve and the second sieve so that the center axis of the first sieve and the center axis of the second sieve become horizontal or vertical.

6. The sorting apparatus according to claim 5, wherein the first sieve or the second sieve rotates in a rotation pattern that includes a rotation in a forward direction by a first angle, then a rotation in a reverse direction by a second angle different from the first angle, and then a rotation in the forward direction by a third angle different from the first and second angles.

7. The sorting apparatus according to claim 5, wherein the shredding unit includes a first rotating blade and a second rotating blade overlapping each other and rotating in directions opposite to each other,
the first rotating blade rotates together with the first sieve by the first driving unit, and
the second rotating blade rotates together with the second sieve by the second driving unit.

8. The sorting apparatus according to claim 2, wherein the trimming unit includes:
a fixed blade arranged in proximity to the mesh of the first sieve or the mesh of the second sieve; and
a rotating blade configured to rotate with respect to the fixed blade, and
the trimming unit is configured to cut the wire-shaped conductors sticking out from the mesh by sandwiching the wire-shaped conductors between the fixed blade and the rotating blade.

9. A sorting method for unsorted nuggets including wire-shaped conductors and non-wire-shaped materials including terminals, the wire-shaped conductors and the non-wire-shaped materials being cut and present in a mixed manner, comprising:
a first sieving step of charging the unsorted nuggets into a first sieve including a mesh, and sieving off the wire-shaped conductors with the first sieve;
a shredding step of shredding the unsorted nuggets remaining in the first sieve after the first sieving step;
a second sieving step of charging the unsorted nuggets shredded in the shredding step into a second sieve including a mesh finer than the mesh of the first sieve to sieve off the wire-shaped conductors with the second sieve; and
a collecting step of collecting the wire-shaped conductors having passed through and sieved off with the mesh of the first sieve and the wire-shaped conductors having passed through and sieved off with the mesh of the second sieve.

10. The sorting method according to claim 9, further comprising
a trimming step of, after the first sieving step or the second sieving step, cutting the wire-shaped conductors sticking out from the mesh of the first sieve or the mesh of the second sieve,
wherein in the collecting step, the wire-shaped conductors having been cut in the trimming step are also collected.
